(19) United States
(12) Patent Application Publication
(10) Pub. No.: US 2002/0153059 A1
(43) Pub. Date: Oct. 24, 2002

(54) Woodturning tool

(76) Inventor: Ernest O. Cassady II, Alva, FL (US)

Correspondence Address: MILLER PATENT SERVICES, 2500 DOCKERY LANE, RALEIGH, NC, 27606, US

(21) Appl. No.: 09/965,282

(22) Filed: Sep. 24, 2001

Related U.S. Application Data
(60) Provisional application No. 60/285,107, filed on Apr. 20, 2001.

(51) Int. Cl. B27C 7/06; B23B 3/26

(52) U.S. Cl. 142/55; 142/40

(57) ABSTRACT

A wood turning tool especially useful for roughing out operations. An angle grinder is mounted to a pair of parallel plates. The parallel plates are coupled together with a screw drive mechanism. The lower of the parallel plates has a perpendicular rod suitable for mating with the lathe banjo. A roughing out cutting operation is carried out by advancing the angle grinder fitted with a circular chain saw blade into the workpiece using the screw drive mechanism. Various texturing operations can be carried out using other cutters and wire brushes. The angle at which the cutting device addresses the workpiece can be adapted to various angles.

### CROSS REFERENCE TO RELATED DOCUMENTS

This application is related to U.S. Provisional Patent Application Serial No. 60/285,107 filed Apr. 20, 2001 to Ernest O. Cassady II, entitled “Wood Turning Tool” which is hereby incorporated by reference as though disclosed fully herein.

### FIELD OF THE INVENTION

This invention relates generally to the field of woodturning. More particularly, this invention relates to a woodturning tool especially suitable for rapid roughing of turning blanks.

### BACKGROUND OF THE INVENTION

The term “woodturning” can broadly relate to any operation wherein a wood or other workpiece is rotated as it is cut by a cutting tool. However, in the context of the present invention, the term “woodturning” is intended to embrace the type of woodturning using a lathe to rotate a workpiece (most commonly wood) coupled to the headstock thereof, with the workpiece being shaped by use of hand held cutting tools such as gouges, chisels, parting tools and scrapers. Such woodturning has been traditionally used to make spindles for architectural purposes (e.g., stair rail and chair spindles) as well as functional bowls and platters.

A lathe, such as that generally used in woodturning is illustrated as lathe 100 of FIG. 1. Such lathes as lathe 100 are available from a number of manufactures. A major supplier of such lathes and related equipment is Craft Supplies USA, 1287 E. 1120 S., Provo, Utah 84606. Lathe 100 is supported by a pair of legs 104 and 108 and has a headstock 112 and a tailstock 116. The headstock 112 carries a motor driven spindle 122 which is aligned with a tailstock center 126. Various control mechanisms are provided for turning such motor driven spindle on and off and for adjusting the rotational speed thereof. The headstock 112 is connected to a bed 130, which is commonly (but not always) made up of a pair of coplanar strips of metal 134 and 138 forming a flat surface that permits the tailstock 116 to slide thereupon to adjust its distance from the headstock 112. The bed 130 also supports a banjo 144 that is designed to support a tool rest 148. The tool rest is locked into place on the banjo using a locking screw with a locking lever 152. The banjo itself is locked to the tool rest using various cam mechanisms controlled by a locking lever 156. Tool rest 148 is generally fitted with a perpendicular rod 160 that mates with an aperture in the top of the banjo 144 as shown. The locking screw attached to lever 156 locks the tool rest in place by frictional force against rod 160 to lock it into a particular height and tool rest angle in the aperture of banjo 144.

Recently, there has been an increased interest in using the woodturning lathe such as 100 as a tool to produce not only conventional functional items, but also to produce very large objects, asymmetrical sculptural objects including pure sculptural objects as well as ornamental bowls having voids, naturally irregular rims and other ornamental features. Often the process of creating such objects begins with a very rough segment of a log, a crotch or a burl that is rough cut with a chain saw. Such rough “blanks” are sometimes (but not always) shaped on a band saw to improve their symmetry and balance prior to mounting on the lathe 100. However, being a non-homogeneous material, the blanks are commonly quite out of balance. This is especially true of crotches, log segments, burls and other irregular starting materials (e.g., when the starting materials are only rough cut by a chain saw).

Generally, it is desirable to remove much of the bulk of the starting blank in a “roughing out” process wherein the blank is rotated at a lower rate of speed on the lathe while a gouge, supported by the tool rest 148, is manually engaged into the rotating blank. This is illustrated in FIG. 2, wherein the rough blank 180 is rotated (counterclockwise as viewed from the tailstock) toward a gouge 184. When the tool such as gouge 184 is properly engaged with the blank 180, the “high spots” are cut off as the blank 180 rotates into the cutting edge 188 of the gouge 184. Tailstock 116 is sometimes engaged for added safety during this roughing out process.

This roughing out process gradually brings the blank 180 into greater symmetry and balance until a suitable shape is achieved. The rough turned blank 180 can then be finish turned at a somewhat higher rate of headstock spindle speed with less danger since the roughed out blank 180 is now more balanced than when the process began.

Some woodturners rough turn wet wood and then allow it to dry before finish turning. When it is dried, the wood will commonly have warped into an oblong or other non-symmetrical shape. A second rough turning process is sometimes carried out at this point to “true up” the workpiece to a symmetrical form, followed by a final finish turning.

These roughing out processes can be tiresome, time consuming, boring and dangerous. Because of this, woodturners are sometimes inclined to rush the process by increasing the lathe speed to dangerous speeds, making an unbalanced workpiece more likely to become unmounted. Moreover, when the workpiece is asymmetrical, the act of roughing the workpiece creates a repetitive jarring of the roughing tool that can translate to the hands, arms and body of the woodturner resulting in fatigue and potential long term injury.

### SUMMARY OF THE INVENTION

The present invention relates generally to a woodturning tool. Objects, advantages and features of the invention will become apparent to those skilled in the art upon consideration of the following detailed description of the invention.

In one embodiment consistent with the present invention a wood turning tool especially useful for roughing out operations is described. An angle grinder is mounted to a pair of parallel plates. The parallel plates are coupled together with a screw drive mechanism. The lower of the parallel plates has a perpendicular rod suitable for mating with the lathe banjo. A roughing out cutting operation is carried out by advancing the angle grinder fitted with a circular chain saw blade into the workpiece using the screw drive mechanism. This provides the advantage of rapid and easy roughing out, particularly roughing out of large or out of balance turning stock. In addition, the grinder can be fitted with a variety of different cutters or other devices such as wire brushes to provide decorative surface texturing to a turned object. The angle at which the cutting device addresses the workpiece can also be adapted to various angles.

A woodturning device, consistent with certain embodiments of the present invention, for cutting a workpiece on a lathe with a banjo has a motor driven rotary cutting device. A mounting arrangement attaches the cutting device to the lathe's banjo. An advancing mechanism is used for advancing the cutting device toward the workpiece.

Another woodturning device, consistent with certain embodiments of the present invention, for cutting a workpiece on a lathe with a banjo has a motor driven rotary cutting device. A first plate is attached to the cutting device. A second plate is attached to the first plate, the first and second plate being oriented substantially parallel to each other. A rod extends substantially perpendicular to the second plate, the rod being suitably sized to mate with an aperture in the lathe's banjo for receiving a tool rest. A threaded rod couples the first and second plates in a manner such that when the rod is rotated, the first plate moves with respect to the second plate in a direction along a plane of the first plate, thus advancing the cutting device toward the workpiece.

Another woodturning device consistent with certain embodiments of the invention for cutting a workpiece on a lathe with a banjo has a motor driven rotary cutting device. A first plate is attached to the cutting device. A second plate is attached to the first plate, the first and second plate being oriented substantially parallel to each other. A rod extends substantially perpendicular to the second plate, the rod being suitably sized to mate with an aperture in the lathe's banjo for receiving a tool rest. A screw drive mechanism couples the first and second plates such that the relative position of the two plates can be adjusted by the screw drive mechanism.

Another woodturning device consistent with certain embodiments of the present invention, provides for cutting a workpiece on a lathe, the lathe having a bed adapted to receive a banjo. The woodturning device has a motor driven rotary cutting device. A rod is connected to the motor driven rotary cutting device. A banjo has an aperture in an upper surface thereof suitable for receiving the rod. The banjo is coupled to a lock mechanism suitable for locking to the lathe bed. The banjo further has an advancing mechanism for advancing the cutting device toward the workpiece.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention which describes certain exemplary embodiments of the invention, taken in conjunction with the accompanying drawings in which:

FIG. 1 is an illustration of a conventional woodturning lathe suitable for use in conjunction with embodiments of the present invention.

FIG. 2 illustrates use of a gouge with a woodturning lathe to rough out a woodturning blank.

FIG. 3 is a perspective view of one illustrative embodiment of a woodturning tool consistent with the present invention.

FIG. 4 is an illustration of the bottom plate of the embodiment of FIG. 3.

FIG. 5 is an illustration of the top plate of the embodiment of FIG. 3.

FIG. 6 is a top view of the woodturning tool of the embodiment of FIG. 3 attached to a lathe.

FIG. 7 illustrates an alternative embodiment consistent with the present invention.

FIG. 8 illustrates another alternative embodiment consistent with the present invention.

FIG. 9 illustrates a first angled tool shaft adapter that can be utilized with embodiments consistent with the present invention.

FIG. 10 illustrates a second angled tool shaft adapter that can be utilized with embodiments consistent with the present invention.

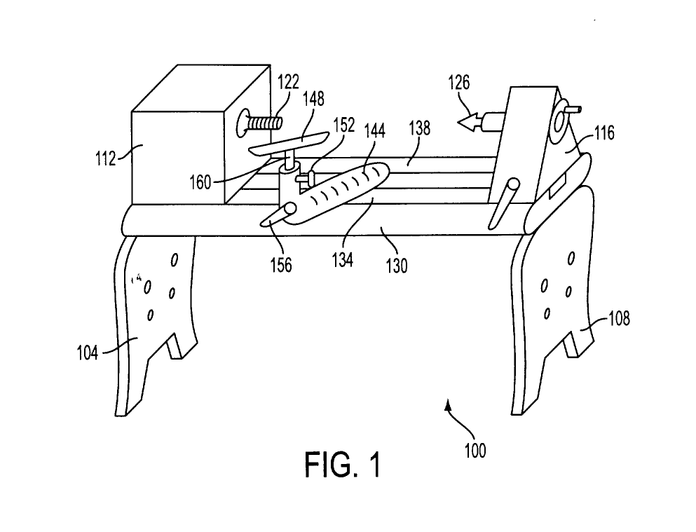

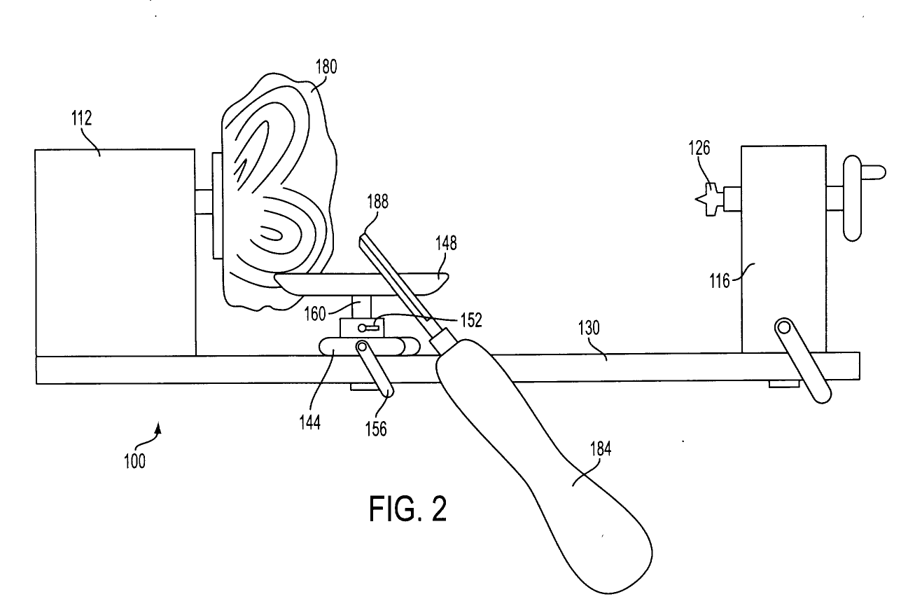

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

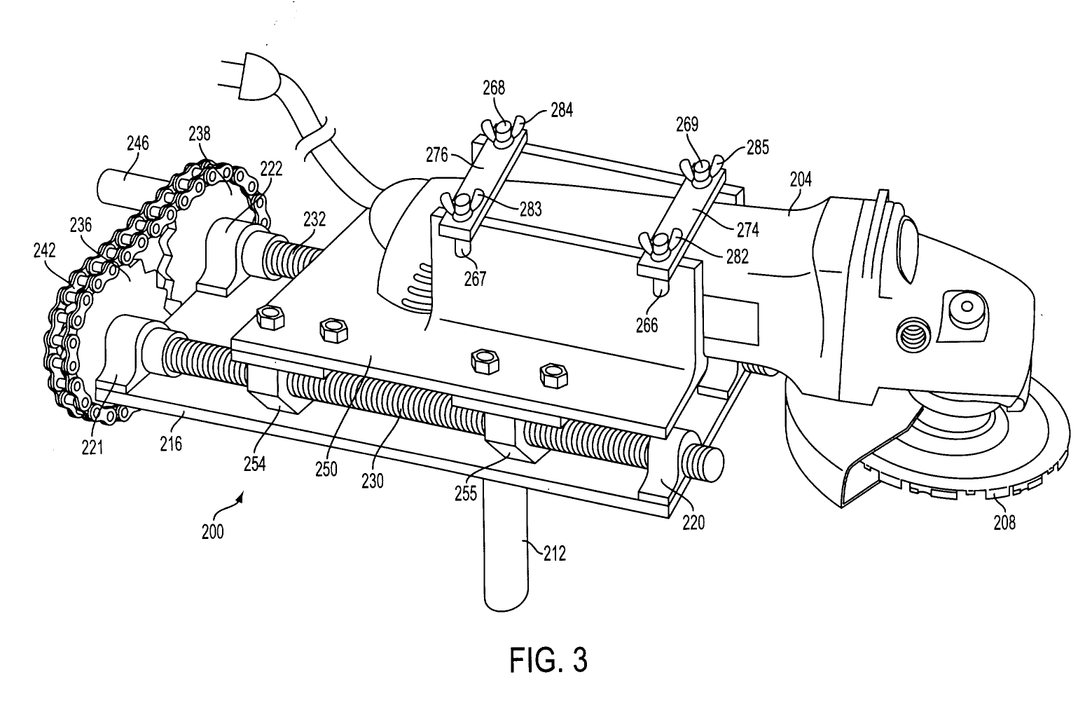

Turning now to FIG. 3, an exemplary prototype embodiment of a woodturning tool 200 consistent with the present invention is illustrated. Tool 200 utilizes a rotary cutting tool such as an angle grinder 204 outfitted with a circular chainsaw blade cutter 208 to simplify the roughing out process. Tool 200 incorporates a shaft or rod 212 that is appropriately sized to fit in the aperture of banjo 144 and lock in place thereon using lever or screw 152. Generally, such banjo apertures are sized to accept tool rest rods that range in size from about ¾ inch to about 1¼ inch in diameter. The length of the rod 212 is selected to place the circular chain saw blade 208 at approximately the center line of the headstock spindle with adjustment available both up and down to optimize the height. The exemplary illustrated prototype embodiment was designed to work in conjunction with lathes such as the Powermatic™ model 4224 woodturning lathe available from Powermatic, 427 Sanford Road, LaVergne, Tenn. 37086, in which rod 212 is approximately six inches in length and one inch in diameter to appropriately mate with this lathe's banjo and provide a suitable range of height adjustment. Of course, these dimensions depend upon the lathe for which the current invention is designed to match and should not be considered limiting.

In the embodiment illustrated, the angle grinder 204 used is the model 1703 variable speed grinder manufactured by Bosch Power Tool Company, 4300 West Patterson Avenue, Chicago, Ill. 60646. Also in the embodiment illustrated, the circular chain saw blade 208 is a 14 tooth Lancelot™ brand blade available from King Arthur's Tools, 2818-D Industrial Plaza Drive, Tallahassee, Fla. 32301. Of course, these specific models are not to be considered limiting, but merely illustrative of commercially available parts used in the prototype embodiment described herein.

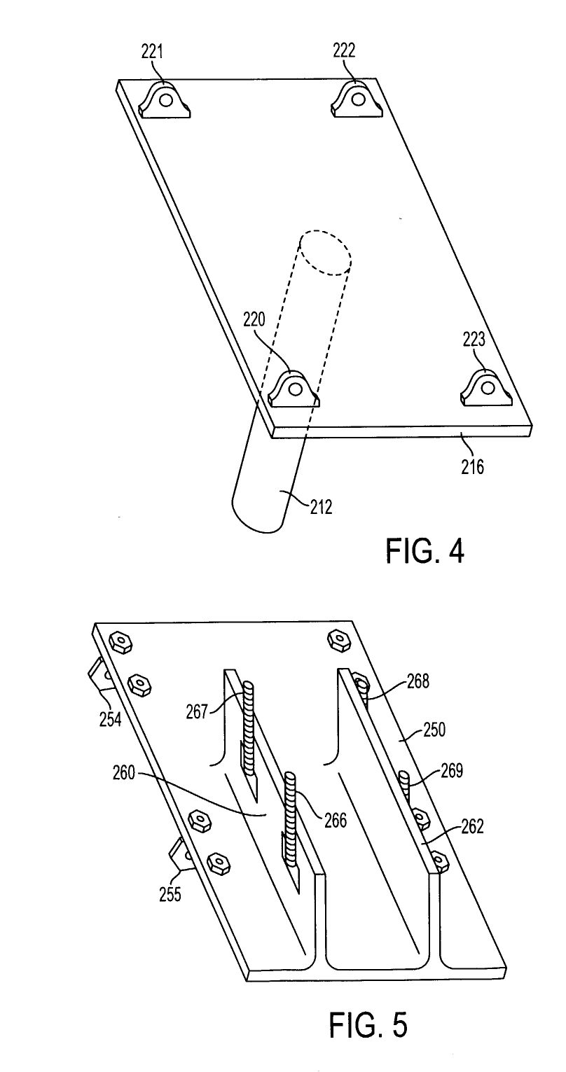

In the prototype embodiment illustrated, rod 212 extends approximately perpendicularly downward from a lower plate 216, but other angles may be suitable including an angle that would slightly incline the circular chain saw blade 208 upward toward a workpiece. Lower plate 216 is also illustrated separately in FIG. 4. Lower plate 216 is made of ¼ inch steel plate material, according to the present embodiment, and incorporates four welded on bearings 220, 221, 222 and 223. In the present embodiment, the top plate is approximately five inches by eight inches, and the lower plate 216 is approximately five inches by eleven inches. The bearings 220, 221, 222 and 223 are adapted to receive a pair of threaded rods 230 and 232. In this embodiment, the threaded rods are freely spin in bearings 220, 221, 222 and 223 and are each locked into place by a chain sprocket 236 and 238 at one end and a washer and bolt at the other. The bearings 220, 221, 222 and 223 may be simple sleeve bearings, or other type of bearings without limitations. The bearings used in the current embodiment were fashioned by drilling out the female threads from nuts and using a lubricant such as grease to permit the threaded rod to easily slide through. The bearings can be locked using any number of locking techniques including, but not limited to, C-clips, E-clips, cotter pins, locking nut arrangements and other arrangements as will be appreciated by those skilled in the art.

Sprockets 236 and 238 are attached at an end of each of the threaded rods 230 and 232. A chain 242 (e.g., a bicycle type chain) connects the two sprockets 236 and 238 together so that rotation of one sprocket and threaded rod causes the other sprocket and threaded rod to rotate simultaneously. A handle 246 is attached to one of the sprockets to facilitate rotation of the threaded rods 230 and 232 by cranking.

Tool 200 also incorporates an upper plate 250 as illustrated both in FIG. 3 and separately in FIG. 5. Upper plate 250 is also made of ¼″ steel plate and is connected to the lower plate 216 using the threaded rod 230 passing through a set of female threaded members shown as 254, and 255. Rod 232 similarly passes through a pair of female threaded members (not shown). In the illustrative embodiment shown, the threaded members 254 and 255 are threaded nuts, each welded to a small plate that is held to the lower surface of upper plate 250 by a pair of bolts and nuts.

Upper plate 250 has a pair of parallel walls 260 and 262 that are also made of ¼″ steel plate and extend upward perpendicularly from the upper surface of upper plate 250 to provide a channel for supporting the grinder 204. The walls are slightly shorter than the height of the grinder and have four threaded rods 266, 267, 268 and 269 welded thereto. The grinder is securely held in place using a pair of metal straps 274 and 276 that have holes lined up with the threaded rod pairs 266 and 267, 268 and 269, respectively. The holes in the metal straps 274 and 276 are engaged with the threaded rods 266 and 267, 268 and 269, respectively and secured in place with wing nuts 282, 283, 284 and 285.

Once assembled, the upper plate 250 and lower plate 216 are moved in relation to one another in their respective planes by cranking the handle 246. This advances the threaded rods 230 and 232 though the threaded members 254 and 255 and the far side threaded members (not shown). This causes the upper plate 250 to move in the direction of the threaded rods 230 and 232 with respect to the lower plate 216, forming one type of screw drive mechanism. The handle 246 is rotated in one direction to advance the cutting tool into the workpiece and in the other direction to extract the cutting tool from the workpiece. In the illustrated embodiment, rotation of handle 246 can cause a total movement of approximately three inches from extreme to extreme, but of course this and other specific dimensions disclosed herein are not to be considered limiting. However, it is desirable to keep the cutting edge 208 close to the rod 212 to provide maximal support and minimum flexing of the tool 200.

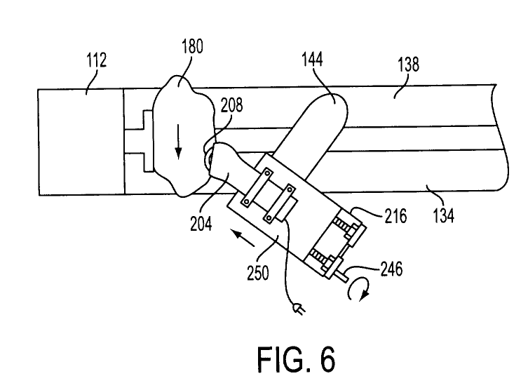

In use, tool 200 is installed on the lathe 100 by removing the tool rest 148 from the lathe 100 and inserting the rod 212 into the aperture of the tool rest 212. This is depicted in FIG. 6. The height of the tool 200 is adjusted so that the cutting edge of the circular chain saw blade 208 is approximately at the center line of the headstock spindle 122. The cutting tool 200 is adjusted to a distance such that a desired area of the workpiece to be cut is just out of reach of the circular chain saw blade 208. For safety, the workpiece is preferably rotated by hand to assure that there is no accidental engagement of the cutting blade and the workpiece until desired by the operator.

For safety, the lathe speed should be adjusted to a low speed setting for continuously variable speed adjustment mechanisms and to the lowest setting for stepped speed adjustment mechanisms. The lathe 100 is then turned on. Assuming the workpiece appears stable and ready for cutting, the grinder 204 is then turned on. Using a slow cranking motion the handle 246 is turned advancing the circular chain saw blade 208 slowly into the workpiece until a desired amount of waste is cut off. The lathe 100 and grinder 204 are then stopped to permit adjustment of the banjo and the relative position of the two plates 216 and 250 to prepare for the next cut. This process is repeated until the blank has been roughed to the desired degree. Normal hand finish turning can then be carried out to provide a smoother finish if desired.

Many variations of the present invention are possible. For example, in other embodiments, the bearings may be attached to the upper plate 250 and the female threaded members may be attached to the lower plate 216. In other embodiments a gear mechanism or a chain mechanism can be used to advance the upper and lower plates. In other embodiments, other mechanisms can be used to move the cutter blade into engagement with the workpiece without use of a parallel plate arrangement.

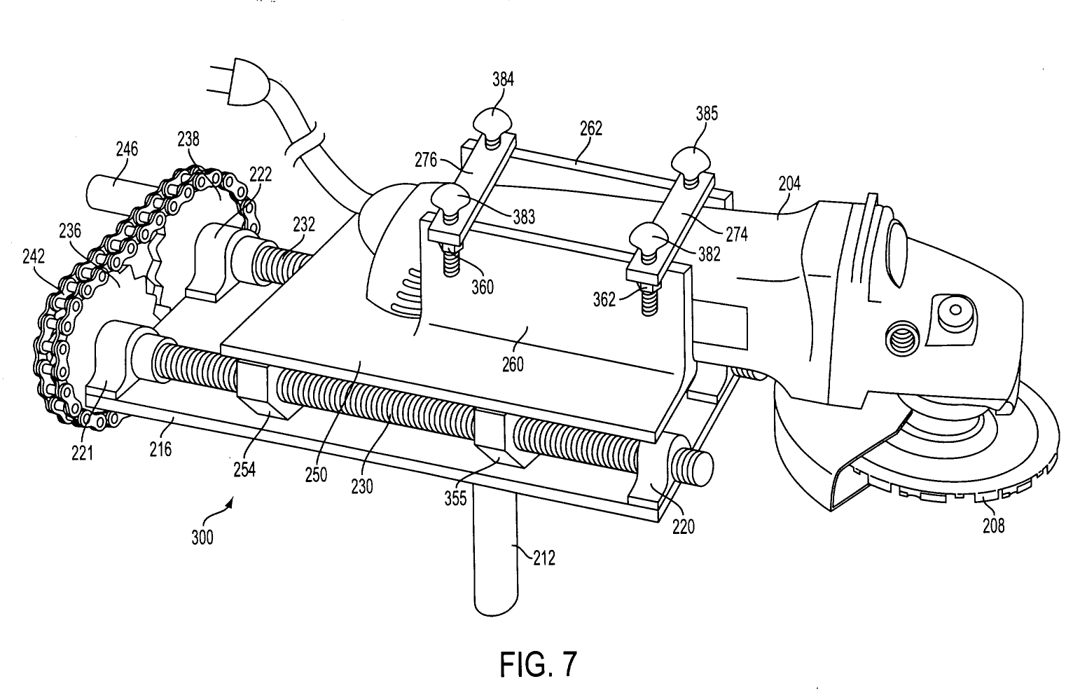

FIG. 7 illustrates an alternative embodiment with slightly different construction than the tool 200 embodiment of FIG. 3, but which operates in a substantially similar manner. In this embodiment, element 254 is a female threaded member which is welded to top plate 250 simplifying construction and eliminating the need for the bolts and plates used in tool 200. In this embodiment, female threaded member 255 of tool 200 is replaced by a bushing 355 (which may be fabricated by drilling the female threads out of a nut, and a lubricant can be used to reduce friction) which is also welded into place rather than being positioned with bolts and a plate as in tool 200. Since only one female thread is used in this embodiment, no alignment of multiple female threaded members is required and the assembly is simplified. In addition, the mechanism for securing the grinder in place may be modified as illustrated. In embodiment 300, nuts 360 and 362 (plus two not shown on the other side) are welded to walls 260 and 262. Straps 274 and 276 are then held in place by thumb screws 382, 383, 384 and 385. Other arrangements can also be used to hold the grinder 204 in place including use of bolts and/or hinges and/or latch assemblies or any other suitable mechanism.

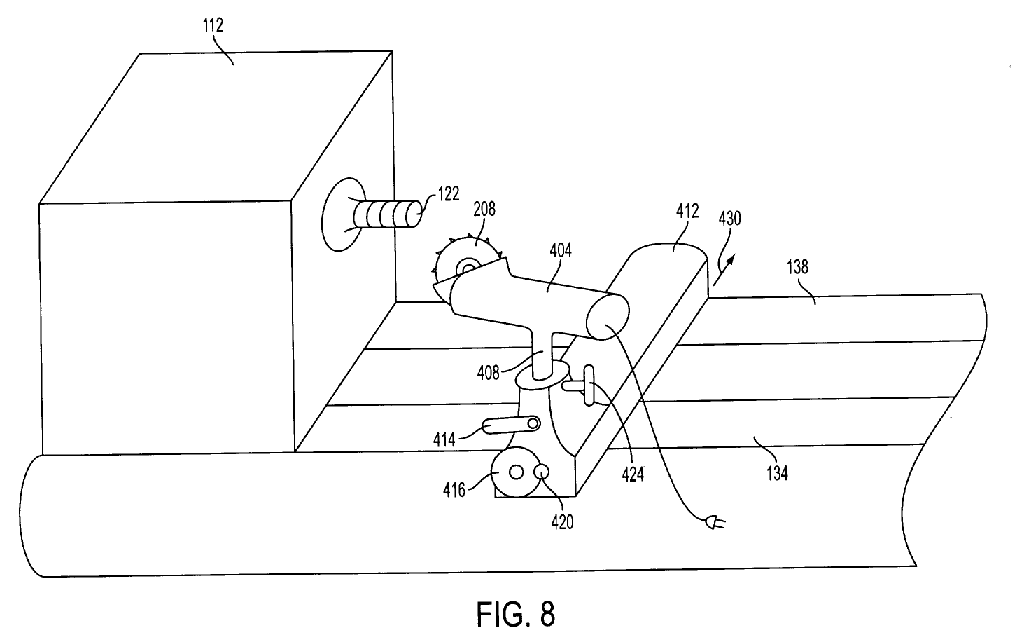

Another alternative embodiment is illustrated in FIG. 8. In this embodiment, a grinder 404 is molded into a housing incorporating a rod 408 for mounting within a specially adapted banjo assembly 412. Banjo 412 utilizes a cam mechanism to lock a locking portion to the bed 130 using a lock lever 414, but incorporates a mechanism for advancing the top portion of the banjo 412 in relation to the locking portion. The advancement is accomplished using a screw drive or other drive mechanism. In the screw drive embodiment, a threaded rod is rotated using a crank 416 with handle 420 to advance the banjo 412 so that the blade 208 engages the workpiece. The position of the grinder 404 is locked into a desired position much the same way as a conventional tool rest would be using a nut or lever 424. In operation, the tool is advanced along the line of the body of the banjo 412 illustrated by arrow 430. Thus, to advance the tool 404 into the workpiece (not shown), the banjo's position is aligned with the direction of the advancement of the tool.

Many other variations will occur to those skilled in the art. For example, while a circular chain saw blade cutter 208 has been found to work quite well, other cutter blades, including but not limited to variations of saw blades, may equivalently be used. Moreover, the present invention, with other types of blades, brushes, etc. and a light engagement with the workpiece can be used to provide ornamental surface texturing of woodturnings in addition to providing efficient roughing out and truing up operations. The variable speed angle grinder 204 has been found to be a convenient device to adapt to the current invention, but other motorized cutting devices may also be adapted without departing from the invention. Custom banjo assemblies can be adapted or the lathe's stock banjo used. While two threaded rods are used in the exemplary prototype of FIG. 3, other embodiments using a single threaded rod used alone or in conjunction with one or more guide mechanisms such as guide rails, or more than three threaded rods are to be considered equivalent. Moreover, other screw drive, gear drive or chain drive mechanisms can be devised to replace the movement driven by the threaded rod of the illustrated embodiment without departing from the present invention. While a pair of parallel plates provide a convenient support mechanism for the present invention due to ready availability, other structures can equally well be used.

The embodiments disclosed are designed to set the blade angle approximately parallel to the lathe bed 130, however, this should not be considered limiting. In other embodiments, there may be an advantage to setting the blade angle at other angles. This can be accomplished in a variety of ways. In one embodiment the mechanism used to hold the grinder 204 may be adapted to lock the grinder at angles other than approximately parallel with the top surfaces of the lathe bed 130. In other embodiments, the tool 200, 300 or 404 can be adapted to address the workpiece at other angles (which might provide for better cutting or for various ornamental effects using cutters or brushes).

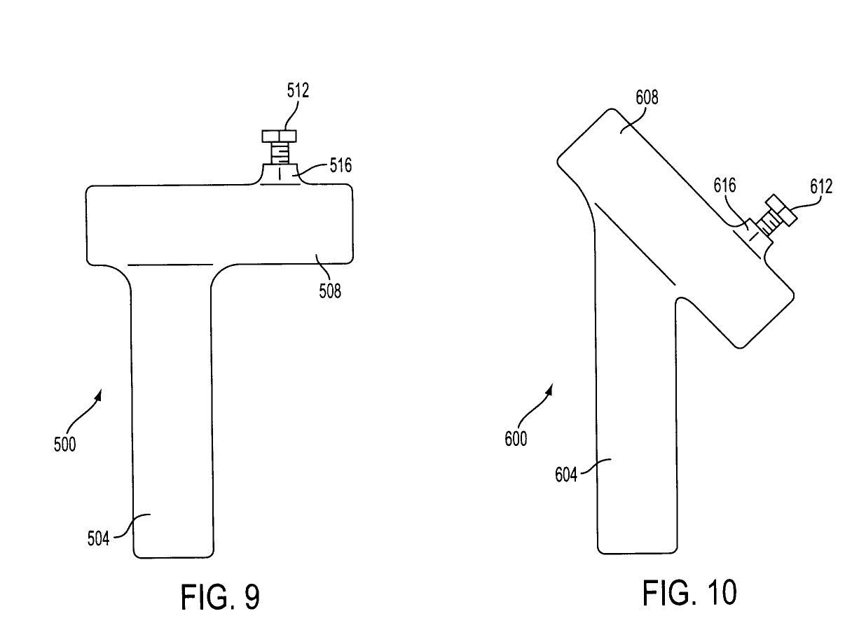

FIG. 9 shows one mechanism for readily adapting the angle of the tool 200, 300 or 400 to address the workpiece at an angle which is perpendicular to the top surface of lathe bed 130. Adapter 500 is fabricated using a steel shaft 504 of suitable diameter and length to fit within the lathe's banjo and provide height adjustment. A steel tubular member 508 is welded to the top of shaft 504 at a right angle. The inner dimension of member 508 is sized to receive the rod (e.g., 212 of tool 200) of the present invention. This effects a rotation of the entire tool by 90 degrees and permits the blade 208 (or other blade device or brush) to address the workpiece at an approximately right angle with respect to the lathe bed 130. The rod (e.g., 212) is locked into place by a lock bolt 512 threaded through the steel tubular member 508 either directly through a threaded hole, or as illustrated through a female threaded part such as a nut 516 welded to tubular member 508 over an aperture therein so that the tip of bolt 512 can frictionally jam the rod (e.g., 212) into a locked position with respect to the tubular member 508. In other embodiments, a locking lever can be substituted for bolt 512 if desired.

FIG. 10 shows a mechanism for adapting the angle of the tool 200, 300 or 400 to address the workpiece at an angle which is approximately 45 degrees to the top surface of lathe bed 130. Adapter 600 is fabricated using a steel shaft 604 of suitable diameter and length to fit within the lathe's banjo and provide height adjustment. A steel tubular member 608 is welded to the top of shaft 604 at a 45 degree angle. The inner dimension of member 608 is sized to receive the rod (e. g., rod 212 of tool 200) of the present invention. This effects a rotation of the entire tool 200 by 45 degrees and permits the blade 208 (or other blade device or brush) to address the workpiece at an approximately 45 degree angle with respect to the lathe bed 130. The rod (e.g., 212) is locked into place by a lock bolt 612 threaded through the steel tubular member 608 either directly through a threaded hole, or as illustrated through a female threaded part such as a nut 616 welded to tubular member 608 over an aperture therein so that the tip of bolt 612 can frictionally jam the rod (e.g., 212) into a locked position with respect to the tubular member 608. In other embodiments, a locking lever can be substituted for bolt 612 if desired.

Those skilled in the art will appreciate that other adapters with other angles can be fabricated in a manner similar to that of adapters 500 and 600 without departing from the invention. Moreover, rather than fixing the angle by welding, pivoting arrangements can be devised to permit the user to select a desired angle without departing from the invention. Additionally, the rod 212 of tools 200 and 300 or rod 408 of tool 404 can be affixed at an angle that permits the cutting blade to address the workpiece at an angle other than parallel to the lathe bed 130 without departing from the invention.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

What is claimed is:

1. A woodturning device for cutting a workpiece on a lathe, the lathe having a banjo, the woodturning device comprising:
a motor driven rotary cutting device;
mounting means for attaching the cutting device to the lathe's banjo; and
advancing means for advancing the cutting device toward the workpiece.

2. The apparatus according to claim 1, wherein the mounting means comprises:
a first plate attached to the cutting device;
a second plate attached to the first plate, the first and second plate being oriented substantially parallel to each other; and
a rod extending substantially perpendicular to the second plate, the rod being suitably sized to mate with an aperture in the lathe's banjo for receiving a tool rest.

3. The apparatus according to claim 2, wherein the advancing means comprises a pair of threaded rods coupling the first and second plate in a manner such that when the rods are rotated, the first plate moves with respect to the second plate in a direction along a plane of the first plate.

4. The apparatus according to claim 3, wherein each of the pair of threaded rods are connected to one of the first and second plates by being locked to a bearing, and wherein the pair of threaded rods are connected to the other of the first and second plates by a plurality of female threaded members.

5. The apparatus according to claim 3, wherein each of the pair of threaded rods terminate in a sprocket, and wherein the sprockets are connected together with a chain.

6. The apparatus according to claim 5, further comprising a crank handle attached to one of the sprockets so that the sprocket can be rotated by hand turning the crank handle to induce rotation of both of the threaded rods simultaneously.

7. The apparatus according to claim 2, wherein the rotary cutting device is releaseably attached to the first plate.

8. The apparatus according to claim 2, wherein the advancing means comprises a threaded rod coupling the first and second plate in a manner such that when the rod is rotated, the first plate moves with respect to the second plate in a direction along a plane of the first plate.

9. The apparatus according to claim 1, wherein the advancing means comprises a threaded rod disposed between the motor driven rotary cutting device and the lathe's banjo in a manner such that when the rod is rotated, the motor driven rotary cutting device is advanced.

10. The apparatus according to claim 1, wherein the lathe has a bed, and wherein the advancing means comprises a threaded rod disposed between the motor driven rotary cutting device and the lathe's bed in a manner such that when the rod is rotated, the motor driven rotary cutting device is advanced.

11. The apparatus according to claim 1, wherein the rotary cutting device comprises an angle grinder.

12. The apparatus according to claim 11, wherein the angle grinder is fitted with a circular chain saw blade.

13. The apparatus according to claim 12, wherein the angle grinder is mounted to the first plate at an angle such that the circular chain saw blade is approximately parallel to the first plate.

14. The apparatus according to claim 1, wherein the rotary cutting device is fitted with one of a wire brush and a cutting blade.

15. The apparatus according to claim 1, wherein the advancing means comprises one of a screw drive mechanism, a gear drive mechanism and a chain drive mechanism.

16. The apparatus according to claim 1, further comprising means for setting an angle at which the cutting device addresses the workpiece.

17. The apparatus according to claim 2, wherein the mounting means comprises:
a shaft suitably sized to attach to the lathe's banjo; and
a tubular member attached to the shaft at a specified angle, and wherein the rod is disposed within the tubular member and locked therein to set an angle at which the cutting device addresses the workpiece.

18. The apparatus according to claim 17, wherein the specified angle is approximately 90 degrees.

19. The apparatus according to claim 17, wherein the specified angle is approximately 45 degrees.

20. A woodturning device for cutting a workpiece on a lathe, the lathe having a banjo, the woodturning device comprising:
a motor driven rotary cutting device;
a first plate attached to the cutting device;
a second plate attached to the first plate, the first and second plate being oriented substantially parallel to each other;
a rod extending substantially perpendicular to the second plate, the rod being suitably sized to mate with an aperture in the lathe's banjo for receiving a tool rest; and
a threaded rod coupling the first and second plate in a manner such that when the rod is rotated, the first plate moves with respect to the second plate in a direction along a plane of the first plate, thus advancing the cutting device toward the workpiece.

21. The apparatus according to claim 20, wherein the threaded rod is connected to one of the first and second plates by being locked to a bearing, and wherein the threaded rod is connected to the other of the first and second plates by a female threaded member.

22. The apparatus according to claim 20, wherein the rotary cutting device comprises an angle grinder.

23. The apparatus according to claim 20, wherein the rotary cutting device is fitted with a circular chain saw blade.

24. The apparatus according to claim 20, wherein the rotary cutting device is fitted with one of a wire brush and a cutting blade.

25. The apparatus according to claim 20, further comprising means for setting an angle at which the cutting device addresses the workpiece.

26. The apparatus according to claim 20, further comprising:
a shaft suitably sized to attach to the lathe's banjo; and
a tubular member attached to the shaft at a specified angle, and wherein the rod is disposed within the tubular member and locked therein to set an angle at which the cutting device addresses the workpiece.

27. The apparatus according to claim 26, wherein the specified angle is approximately 90 degrees.

28. The apparatus according to claim 26, wherein the specified angle is approximately 45 degrees.

29. A woodturning device for cutting a workpiece on a lathe, the lathe having a banjo, the woodturning device comprising:
a motor driven rotary cutting device;
a first plate attached to the cutting device;
a second plate attached to the first plate, the first and second plate being oriented substantially parallel to each other;
a rod extending substantially perpendicular to the second plate, the rod being suitably sized to mate with an aperture in the lathe's banjo for receiving a tool rest; and
a screw drive mechanism coupling the first and second plates such that the relative position of the two plates can be adjusted by the screw drive mechanism.

30. The apparatus according to claim 29, wherein the rotary cutting device comprises an angle grinder.

31. The apparatus according to claim 29, wherein the rotary cutting device is fitted with a circular chain saw blade.

32. The apparatus according to claim 29, wherein the rotary cutting device is fitted with one of a wire brush and a cutting blade.

33. The apparatus according to claim 29, further comprising:
a shaft suitably sized to attach to the lathe's banjo; and
a tubular member attached to the shaft at a specified angle, and wherein the rod is disposed within the tubular member and locked therein to set an angle at which the cutting device addresses the workpiece.

34. The apparatus according to claim 33, wherein the specified angle is approximately 90 degrees.

35. The apparatus according to claim 33, wherein the specified angle is approximately 45 degrees.

36. The apparatus according to claim 29, further comprising means for setting an angle at which the cutting device addresses the workpiece.

37. A woodturning device for cutting a workpiece on a lathe, the lathe having a bed adapted to receive a banjo, the woodturning device comprising:
a motor driven rotary cutting device;
a rod connected to the motor driven rotary cutting device;
a banjo having an aperture in an upper surface thereof suitable for receiving the rod;
the banjo being coupled to a lock mechanism suitable for locking to the lathe bed; and
the banjo further comprising advancing means for advancing the cutting device toward the workpiece.

38. The apparatus according to claim 37, wherein the advancing means comprises a threaded rod coupling the lock mechanism to the banjo so that when the rod is rotated, the banjo moves with respect to the locking mechanism.

39. The apparatus according to claim 37, wherein the threaded rod terminates in a crank handle to facilitate rotation of the threaded rod.

40. The apparatus according to claim 37, wherein the rotary cutting device is fitted with a circular chain saw blade.

41. The apparatus according to claim 40, wherein the lathe has a headstock spindle, and wherein the rotary cutting device is mounted at an angle such that the circular chain saw blade is approximately parallel to the lathe bed at approximately a height of the headstock spindle.

42. The apparatus according to claim 37, wherein the advancing means comprises one of a screw drive mechanism, a gear drive mechanism and a chain drive mechanism.

43. The apparatus according to claim 37, further comprising means for setting an angle at which the cutting device addresses the workpiece.
